(19) United States
(12) Patent Application Publication
(10) Pub. No.: US 2009/0165543 A1
(43) Pub. Date: Jul. 2, 2009

(54) ERROR DETECTION APPARATUS FOR NOx SENSOR AND EXHAUST GAS CLEANING SYSTEM HAVING THE SAME

(75) Inventor: Keiji WAKAHARA, Inazawa-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/342,307

(22) Filed: Dec. 23, 2008

(30) Foreign Application Priority Data
Dec. 27, 2007 (JP) 2007-336957

(51) Int. Cl. G01M 15/04

(52) U.S. Cl. 73/114.61

(57) ABSTRACT

An error detection apparatus detects an error of a NOx sensor, which is located on a downstream side of a NOx remover in a discharge passage of the internal combustion engine. In the error detection apparatus, a running state detector detects a running state of the internal combustion engine. An unsteady state determiner determines whether the running state of the internal combustion engine detected by the running state detector is unsteady or not. A NOx amount retriever retrieves the amount of NOx on the downstream side of the NOx sensor by receiving an output signal of the NOx sensor. An error determiner determines the error of the NOx sensor on the basis of the amount of the NOx that is retrieved by the NOx amount retriever during a predetermined period under the running state of the internal combustion engine including the unsteady state determined by the unsteady state determiner.

### CROSS REFERENCE TO RELATED APPLICATION

This application is based on and incorporates herein by reference Japanese Patent Application No. 2007-336957 filed on Dec. 27, 2007.

### BACKGROUND OF THE INVENTION

1. Field of the Invention

The present invention relates to an error detection apparatus for a NOx sensor, which detects an error of the NOx sensor that is installed on a downstream side of a NOx removal device, and an exhaust gas cleaning system that includes the error detection apparatus.

2. Description of Related Art

Conventionally, an exhaust gas cleaning system, in which a NOx sensor is installed on a downstream side of a NOx removal device, is known. In the exhaust gas cleaning system, the amount of NOx that is removed by the NOx remover is determined on the basis of an output signal of the NOx sensor (see JP2002-47979A, for example).

In such an exhaust gas cleaning system, it is necessary to detect an error of the NOx sensor that is caused by deterioration, failure, etc., in order to detect the amount of NOx that is removed by the NOx remover with high accuracy.

In the exhaust gas cleaning system disclosed in JP2002-47979A, an error of the exhaust gas cleaning apparatus, which includes the NOx sensor, is detected by determining whether the output signal of the NOx sensor has a value corresponding to zero NOx emission under an operational state such as a fuel cut state where an amount of NOx that is emitted from an internal combustion engine is estimated to be zero.

JP2003-314258A discloses another technique for detecting the error of an exhaust gas cleaning system. In detecting the error of the NOx sensor in the technique, supply of reducing agent to a NOx catalyst is stopped, and a value of a concentration of NOx, which is detected by the NOx sensor, is evaluated.

However, by the method disclosed in JP2002-47979A, in which the error of the NOx sensor is detected by determining whether the output signal of the NOx sensor has the value corresponding to zero NOx emission under the operational state where the amount of NOx emitted from the internal combustion engine is estimated to be zero, it is difficult to distinguish between a normal state and an erroneous state of the NOx sensor with high accuracy because the level of the output signal is low even when the NOx sensor has no error.

By the method disclosed in JP2003-314258A, in which the supply of the reducing agent to the NOx catalyst is stopped every time when the error of the NOx sensor is detected, NOx that is left without being reduced is emitted every time when the error of the NOx sensor is detected.

### SUMMARY OF THE INVENTION

The present invention is made in view of the above-mentioned problem. Thus, it is an objective of the present invention to provide an error detection apparatus for a NOx sensor, which can detect an error of the NOx sensor with high accuracy and can decrease the emission of NOx in detecting the error of the NOx sensor, and an exhaust gas cleaning system that includes the error detection apparatus for NOx sensor.

To achieve the objective of the present invention, there is provided an error detection apparatus for detecting an error of a NOx sensor. The NOx sensor is located on a downstream side of a NOx remover in a discharge passage of the internal combustion engine to detect an amount of NOx that is left without being removed by the NOx remover. The error detection apparatus includes a running state detector, an unsteady state determiner, a NOx amount retriever and an error determiner. The running state detector detects a running state of the internal combustion engine. The unsteady state determiner determines whether the running state of the internal combustion engine detected by the running state detector is an unsteady state or not. The NOx amount retriever retrieves the amount of NOx on the downstream side of the NOx sensor by receiving an output signal of the NOx sensor. The error determiner determines the error of the NOx sensor on the basis of the amount of NOx that is retrieved by the NOx amount retriever during a predetermined period under the running state of the internal combustion engine including the unsteady state determined by the unsteady state determiner.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram showing an exhaust gas cleaning system according to one embodiment of the present invention;

FIG. 2 is a flowchart showing an aqueous urea supply control routine by the exhaust gas cleaning system according to the one embodiment;

FIG. 3 is a flowchart showing a procedure for detecting an error of a NOx sensor; and

FIG. 4 is a time chart showing an output of the NOx sensor in detecting the error of the NOx sensor.

### DETAILED DESCRIPTION OF PREFERRED EMBODIMENTS

Embodiments of the present invention will be described hereafter with reference to the accompanying drawings.

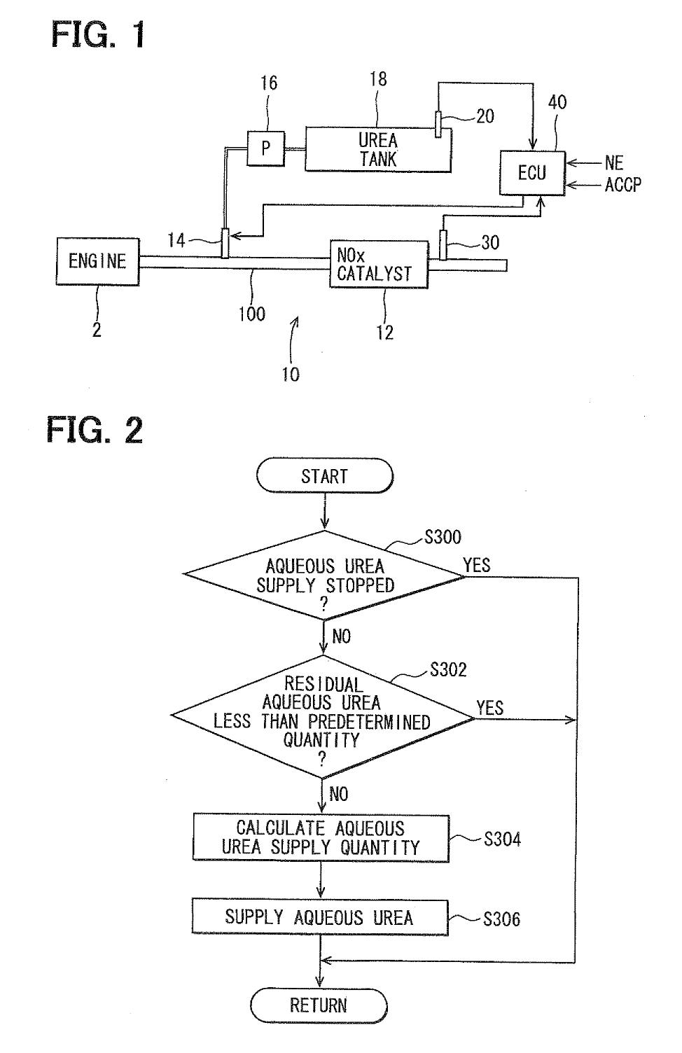

FIG. 1 shows an exhaust gas cleaning system 10 according to one embodiment of the present invention.

The exhaust gas cleaning system 10 according to this embodiment has a NOx catalyst 12, a urea addition valve 14, a pump 16, a urea tank 18, a level sensor 20, a NOx sensor 30 and an electronic control unit (ECU) 40. The exhaust gas cleaning system 10 is a system that cleans up the exhaust gas emitted from a diesel engine (hereafter referred to just as “engine”) 2 to an exhaust passage 100. Fuel injection valves inject fuel, which is accumulated in a common rail, into the engine 2.

The NOx catalyst 12 is located in the exhaust passage 100. The urea addition valve 14, which serves as a reducer addition device, is located on the upstream side of the NOx catalyst 12 in the exhaust passage 100. The NOx catalyst 12 and the urea addition valve 14 correspond to a NOx remover in the claims.

The urea addition valve 14 is an electromagnetic open/close valve that sprays aqueous urea solution, which serves as reducing agent, to the upstream side of the NOx catalyst 12. The aqueous urea solution sprayed from the urea addition valve 14 is adsorbed on the NOx catalyst 12. When the temperature of exhaust gas is larger than a predetermined value, the aqueous urea solution is hydrolyzed and decomposed into ammonia and carbon dioxide. Then, the ammonia, which is generated by hydrolysis, reduces NOx at the NOx catalyst 12.

The pump 16 supplies the aqueous urea solution from the urea tank 18 to the urea addition valve 14. The level sensor 20 detects the residual quantity of the aqueous urea solution in the urea tank 18.

The NOx sensor 30 is located on the downstream side of the NOx catalyst 12. The NOx sensor 30 detects the amount of NOx, specifically detects the concentration of NOx on the downstream side of the NOx catalyst 12. The NOx sensor 30 is activated when it is heated by a heater to a predetermined temperature or higher. The NOx sensor 30 outputs detection signals in accordance with the concentration of NOx.

The ECU 40, which serves as an error detection apparatus for the NOx sensor 30, has a CPU, a RAM, a ROM, a rewritable storage device such as a flash memory, etc (not shown). The ECU 40 functions as a running state detector, a reducer calculator, an unsteady state determiner, a NOx amount retriever, a NOx amount cumulator, an error determiner, a NOx remover controller and an error checker, which are described below, by a control program memorized in storage devices of the ECU 40 such as the ROM, the flash memory, etc.

As the running state detector, the ECU 40 detects a running state of the engine 2 from the detection signals of sensors such as the NOx sensor 30, an engine speed sensor (not shown) and an accelerator opening sensor (not shown) The ECU 40 controls injection timings and injection quantities of the fuel injection valves and actions of other devices in accordance with the detected running state of the engine 2.

As the reducer calculator, the ECU 40 detects an engine speed NE from the detection signal of the engine speed sensor. The ECU 40 also calculates the fuel injection quantity that is commanded to the fuel injection valves from the detection signal of the accelerator opening sensor. Then, the ECU 40 calculates the amount of NOx, which should be emitted from the engine 2, with reference to a map in accordance with the engine speed NE and the fuel injection quantity. Moreover, the ECU 40 calculates an amount of the aqueous urea solution, which should be supplied from the urea addition valve 14 to the NOx catalyst 12 in accordance with the amount of NOx emission, with reference to a map in accordance with the engine speed NE and the fuel injection quantity.

The engine speed NE and the fuel injection quantity, which indicate the running state of the engine 2, can be detected by common sensors that are equipped not only in the diesel engine 2 but also in other kinds of engines such as a gasoline engine regardless of configurations of the engines. Therefore, it is possible to calculate the amount of NOx, which should be emitted from the engine 2, and the amount of the aqueous urea solution, which should be supplied in accordance with the amount of NOx emission, without providing additional sensors.

When the running state of the engine 2 is steady, the amount of NOx that is emitted from the engine 2 is almost constant. Therefore, by supplying a certain amount of the aqueous urea solution, which is required for reducing NOx at the NOx catalyst 12, from the urea addition valve 14 to the NOx catalyst 12, the amount of NOx that is emitted from the NOx catalyst 12 becomes approximately zero.

In contrast, when an accelerator pedal is pressed or returned, the fuel injection quantity fluctuates in accordance with a degree of an accelerator opening ACCP, and the running state of the engine 2 becomes unsteady. Also when the running state of the engine 2 is unsteady, the ECU 40 calculates the amount of the aqueous urea solution, which should be supplied in accordance with the amount of NOx emission, with reference to the map in accordance with the engine speed NE and the fuel injection quantity, in the same manner as when the running state of the engine 2 is steady. Then, the aqueous urea solution is supplied from the urea addition valve 14 to the NOx catalyst 12. However, there is a response delay from the calculation of the amount of the aqueous urea solution to the supply of the calculated amount of the aqueous urea solution from the urea addition valve 14 to the NOx catalyst 12. Furthermore, there is another response delay from the supply of the aqueous urea solution to the hydrolysis of the aqueous urea solution and the reduction reaction of NOx at the NOx catalyst 12. As a result, when the running state of the engine 2 is unsteady, more NOx is left without being reduced and is emitted from the NOx catalyst 12 than when the running state of the engine 2 is steady.

When an EGR (exhaust gas recirculation) valve is installed in the exhaust gas cleaning system, it is desirable to detect an EGR amount from the opening degree of the EGR valve and to calculate the amount of NOx, which should be emitted from the engine 2, and the amount of the aqueous urea solution, which should be supplied in accordance with the amount of NOx emission, with reference to a map in accordance with the engine speed NE, the fuel injection quantity and the EGR amount. This is because the amount of NOx emission decreases in accordance with an increase of the EGR amount, and the amount of NOx emission increases in accordance with a decrease of the EGR amount.

The ECU 40 may calculate the amount of the aqueous urea solution, which should be supplied from the urea addition valve 14 to the NOx catalyst 12, by open controls. Alternatively, the ECU 40 may calculate the amount of the aqueous urea solution, which should be supplied from the urea addition valve 14 to the NOx catalyst 12, by getting feedbacks of the detection signals of the NOx sensor 30.

Moreover, the ECU 40 may learn aqueous urea supply characteristics of the urea addition valve 14 due to age deterioration etc., on the basis of the detection signals of the NOx sensor 30.

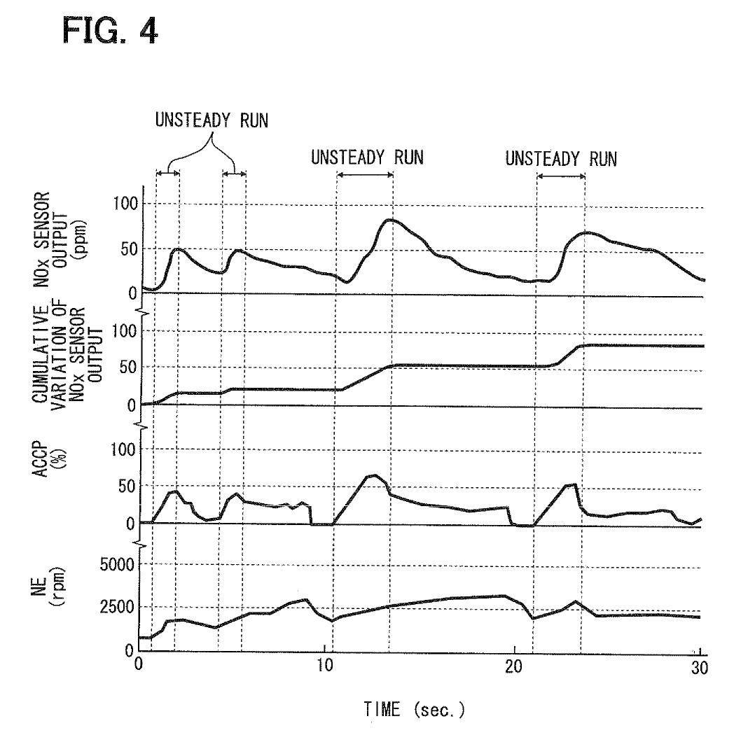

As the unsteady state determiner, the ECU 40 determines that the running state of the engine 2 is unsteady while a variation of the fuel injection quantity is larger than a predetermined value. A variation of the degree of the accelerator opening ACCP, which is shown in FIG. 4, is regarded as the variation of the fuel injection quantity. As shown in FIG. 4, the ECU 40 determines that the running state of the engine 2 is unsteady while the variation of the degree of the accelerator opening ACCP is larger than a predetermined positive value.

In this embodiment, a delay of the detection operation by the NOx sensor 30 from a change of the running state of the engine 2 is taken into consideration. As shown in FIG. 4, the ECU 40 determines that the running state of the engine 2 is unsteady not only while the variation of the degree of the accelerator opening ACCP is larger than the predetermined positive value but also in a predetermined period when the variation of the degree of the accelerator opening ACCP is changing from positive value to zero or less after the variation of the degree of the accelerator opening ACCP is larger than the predetermined positive value.

Alternatively, the ECU 40 may determine that the running state of the engine 2 is unsteady while the variation of the degree of the accelerator opening ACCP is smaller than a predetermined negative value and in a predetermined period when the variation of the degree of the accelerator opening ACCP is changing from negative value to zero or more after the variation of the degree of the accelerator opening ACCP is smaller than the predetermined negative value. Also in the unsteady running state of the engine 2 determined as above, there is a response delay from the calculation of the amount of the aqueous urea solution to the supply of the calculated amount of the aqueous urea solution from the urea addition valve 14 to the NOx catalyst 12. Furthermore, there is another response delay from the supply of the aqueous urea solution to the hydrolysis of the aqueous urea solution and the reduction reaction of NOx at the NOx catalyst 12. Therefore, NOx can be left without being reduced and can be emitted from the NOx catalyst 12.

As the NOx amount retriever, the ECU 40 calculates the amount of NOx on the downstream side of the NOx catalyst 12 from the output signal of the NOx sensor 30, and retrieves the calculation result as the amount of NOx.

As the NOx amount cumulator, the ECU 40 calculates a cumulative value of the amount of NOx that is retrieved by the NOx amount retriever during a predetermined period in an engine running time, which includes a period when the running state of the engine 2 is unsteady. Alternatively, the ECU 40 calculates a cumulative value of the variation of the amount of NOx that is retrieved by the NOx amount retriever during the predetermined period in the engine running time, which includes the period when the running state of the engine 2 is unsteady.

In the example shown in FIG. 4, the variation of the concentration of NOx, which is detected by the NOx sensor 30, is summed up to the cumulative value when the variation of the concentration of NOx has a positive value under the unsteady running state of the engine 2 in which the variation of the degree of the accelerator opening ACCP is larger than the predetermined positive value. The variation of the concentration of NOx is not summed up to the cumulative value when the variation of the concentration of NOx is zero or less.

As shown in FIG. 4, the variation of the concentration of NOx is summed up to the cumulative value when the concentration of NOx is increasing with a delay from the increase of the fuel injection quantity under the condition that the variation of the degree of the accelerator opening ACCP is larger than the predetermined positive value, that is, under the condition that the variation of the fuel injection quantity is larger than a predetermined positive value. The predetermined period for calculating the cumulative value of the amount of NOx may include one unsteady running state of the engine 2. Alternatively, two or more unsteady running states may be included in the predetermined period for calculating the cumulative value of the amount of NOx.

Alternatively, under the unsteady running state of the engine 2 in which the variation of the degree of the accelerator opening ACCP is smaller than the predetermined negative value, the ECU 40 may sum up the variation of the concentration of NOx when the variation of the concentration of NOx has a negative value and stop summing up the variation of the concentration of NOx when the variation of the concentration of NOx is zero or more.

As the error determiner, the ECU 40 determines an error of the NOx sensor 30 on the basis of the amount of NOx, which is retrieved by the NOx amount retriever in the predetermined period in the engine running time, which includes the period when the running state of the engine 2 is unsteady. The ECU 40 determines that the NOx sensor 30 has an error if the amount of NOx, which is retrieved by the NOx amount retriever in the predetermined period, is out of a predetermined range. If the amount of NOx is larger than the predetermined range, the NOx sensor 30 can have such an error that the output signal of the NOx sensor 30 has an excessively large level due to gain shift. If the amount of NOx is smaller than the predetermined range, the NOx sensor 30 can have such an error that the output signal of a NOx sensor 30 has an excessively small level due to gain shift.

The ECU 40 may detect the error of the NOx sensor 30 on the basis of the cumulative value of the amount of NOx or on the basis of the cumulative value of the variation of the amount of NOx calculated by the above-described NOx amount cumulator. In this case, the ECU 40 may detect the error of the NOx sensor 30 on the basis of the sum of the cumulative values of the amount of NOx, which are summed up in multiple unsteady running states of the engine 2, or on the basis of the sum of the cumulative values of the variation of the amount of NOx, which are summed up in the multiple unsteady running states of the engine 2. Moreover, it is also possible to calculate an average of the cumulative values, which are summed up in the multiple unsteady running states, or to calculate an average of two or more sets of the cumulative values, which are summed up in two or more series of the multiple unsteady running states, respectively. The error of the NOx sensor 30 may be detected on the basis of the average of the cumulative values.

As the NOx remover controller, the ECU 40 may further check the error of the NOx sensor 30 after the error determiner determines the error of the NOx sensor 30 on the basis of the amount of NOx, which is retrieved by the NOx amount retriever.

In order to check the error of the NOx sensor 30, the ECU 40 stops supplying the aqueous urea solution from the urea addition valve 14 to the NOx catalyst 12, or decreases the amount of the aqueous urea solution, which is actually supplied from the urea addition valve 14 to the NOx catalyst 12, from the amount of the aqueous urea solution, which is calculated by the reducer calculator with reference to the map. Thereby, the amount of aqueous urea solution becomes insufficient for reducing all NOx at the NOx catalyst 12, and NOx that is left without being reduced is emitted from the NOx catalyst 12.

As the error checker, the ECU 40 lets the NOx remover controller stop supplying the aqueous urea solution from the urea addition valve 14 to the NOx catalyst 12, or decreases the amount of the aqueous urea solution, which is actually supplied from the urea addition valve 14 to the NOx catalyst 12, from the amount of the aqueous urea solution, which is calculated by the reducer calculator with reference to the map. Then, the ECU 40 checks the error of the NOx sensor 30 on the basis of the output signal of the NOx sensor 30 that is outputted after the NOx remover controller stops supplying the aqueous urea solution or decreases the amount of the aqueous urea solution supplied from the urea addition valve 14 to the NOx catalyst 12

If the NOx sensor 30 has no error, the NOx sensor 30 outputs the output signal having a level corresponding to the concentration of NOx that is emitted from the NOx catalyst 12 after the supply of the aqueous urea solution to the NOx catalyst 12 is stopped or decreased. If the NOx sensor 30 has deterioration or failure, the NOx sensor 30 outputs the output signal having a level that is out of an appropriate range.

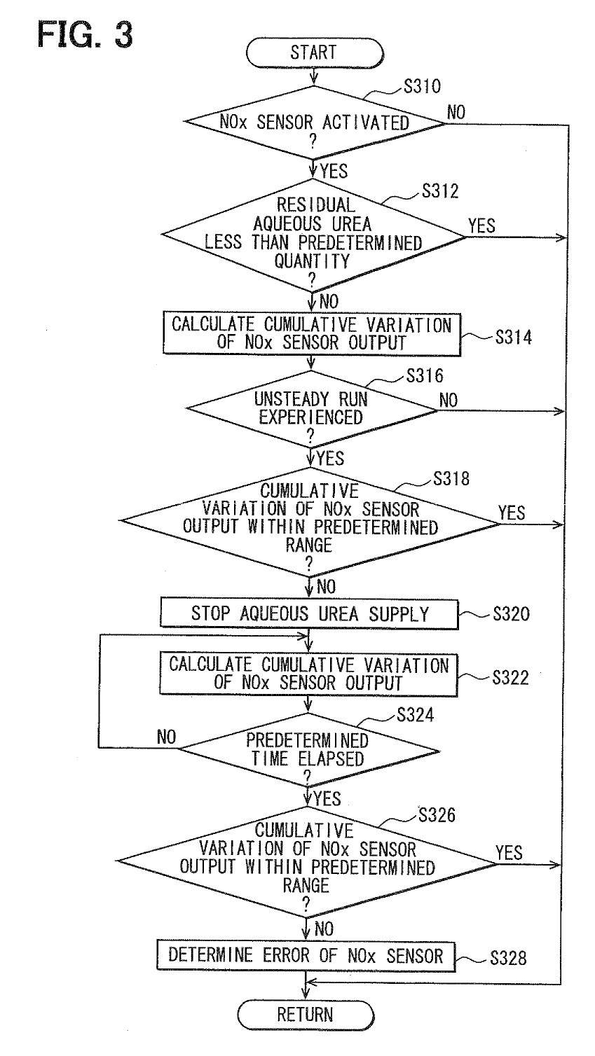

A procedure of the aqueous urea supply control by the exhaust gas cleaning system 10 will be described below with reference to an aqueous urea supply control routine shown in FIG. 2. A procedure of the error detection of the NOx sensor 30 by the exhaust gas cleaning system 10 will be described below with reference to a NOx sensor's error detection routine shown in FIG. 3 and a time chart of FIG. 4, which shows the output of the NOx sensor 30 in detecting the error of the NOx sensor 30. The routines shown in FIGS. 2, 3 are performed at all times. The routines shown in FIGS. 2, 3 are memorized in a storage device of the ECU 40 such as the ROM and the flash memory.

In the aqueous urea supply control routine shown in FIG. 2, the ECU 40 determines whether the supply of the aqueous urea solution is stopped by the NOx sensor's error detection routine, which will be described later, or not at step S300. If the supply of the aqueous urea solution is stopped (Yes at step S300), the ECU 40 ends the aqueous urea supply control routine.

If the supply of the aqueous urea solution is not stopped (No at step S300), the ECU 40 determines whether the residual amount of the aqueous urea solution in the urea tank 18 is less than a predetermined quantity or not, on the basis of an output signal of the level sensor 20, at step S302. If the residual quantity of the aqueous urea solution in the urea tank 18 is less than the predetermined quantity (Yes at step S302), the ECU 40 ends the aqueous urea supply control routine.

If the residual quantity of the aqueous urea solution in the urea tank 18 is not less than the predetermined quantity (No at step S302), the ECU 40 calculates the amount of the aqueous urea solution, which should be supplied from the urea addition valve 14 to the NOx catalyst 12 in accordance with the amount of NOx that is emitted from the engine 2, from the engine speed NE and the fuel injection quantity.

In step S306, the ECU 40 supplies the calculated amount of the aqueous urea solution from the urea addition valve 14 to the NOx catalyst 12, and ends the aqueous urea supply control routine.

In the error detection routine shown in FIG. 3, firstly the ECU 40 determines whether the NOx sensor 30 is activated or not at step S310. Specifically, the ECU 40 determines whether a heater of the NOx sensor 30 is kept energized for more than a predetermined time or not, for example, to determine whether the NOx sensor 30 is activated or not. If the NOx sensor 30 is not activated (No at step S310), the ECU 40 ends the error detection routine.

If the NOx sensor 30 is activated (Yes at step S310), the ECU 40 determines whether the residual quantity of the aqueous urea solution in the urea tank 18 is less than a predetermined quantity or not, on the basis of the output signal of the level sensor 20, at step S312. If the residual quantity of the aqueous urea solution in the urea tank 18 is less than the predetermined quantity (Yes at step S312), the ECU 40 determines that it is impossible to supply a predetermined target quantity of the aqueous urea solution from the urea addition valve 14 to the NOx catalyst 12 and that the error of the NOx sensor 30 cannot be properly detected. Then, the ECU 40 ends the error detection routine.

If the residual quantity of the aqueous urea solution in the urea tank 18 is not less than the predetermined quantity (No at step S312), the ECU 40 sums up the variation of the concentration of NOx, which is detected by the NOx sensor 30, to the cumulative value at step S314 provided the variation of the concentration of NOx has the positive value. The ECU 40 does not sum up the variation of the concentration of NOx when the variation of the concentration of NOx is zero or less.

In step S316, the ECU 40 determines whether the exhaust gas cleaning system has experienced a predetermined unsteady state of the engine 2 such as the unsteady running states that are repeated a predetermined number of times. If the system has not experienced the predetermined unsteady state (No at step S316), the ECU 40 determines that a timing for detecting the error of the NOx sensor 30 has not come, and ends the error detection routine.

If the exhaust gas cleaning system has experienced the predetermined unsteady state of the engine 2 (Yes at step S316), the ECU 40 determines whether the cumulative value of the variation of the concentration of NOx is within a predetermined range or not at step S318. Here, the cumulative value of the variation of the concentration of NOx may be the sum of the cumulative value of the variation of the concentration of NOx, which are summed up in the multiple unsteady running states of the engine 2. Moreover, it is also possible to calculate the average of the cumulative values, which are summed up in the multiple unsteady running states, or to calculate the average of two or more sets of the cumulative values, which are summed up in two or more series of the multiple unsteady running states, respectively. The cumulative value of the variation of concentration of NOx may be the average of the cumulative values calculated as described above.

The ECU 40 determines that the cumulative value of the variation of the concentration of NOx is within the predetermined range when a relationship of k1 (cumulative value of variation of concentration of NOx)<k2 is satisfied. In this relationship, k1, k2 are predetermined values, and k1 is smaller than k2. The ECU 40 sets the predetermined values k1, k2 in accordance with the variation of the degree of the accelerator opening ACCP, or sets the predetermined values k1, k2 as constant values.

If k1≦(cumulative value of variation of concentration of NOx)≦k2, that is, if the cumulative value of the variation of the concentration of NOx is within the predetermined range (Yes at step S318), the ECU 40 determines that the NOx sensor 30 correctly detects the amount of NOx, which is emitted from the NOx catalyst 12 in the unsteady running state of the engine 2 due to the response delay of the NOx reduction at the NOx catalyst 12. Then, the ECU 40 ends the error detection routine.

If (cumulative value of variation of concentration of NOx)<k1 or (cumulative value of variation of concentration of NOx)>k2, that is, if the cumulative value of the variation of the concentration of NOx is out of the predetermined range (No at step S318), the ECU 40 determines that the NOx sensor 30 does not correctly detect the amount of NOx, which is emitted from the NOx catalyst 12 in the unsteady running state of the engine 2 due to the response delay of the NOx reduction at the NOx catalyst 12. Then, the ECU 40 stops supplying the aqueous urea solution from the urea addition valve 14 to the NOx catalyst 12 at step S320. When the supply of the aqueous urea solution from the urea addition valve 14 to the NOx catalyst 12 is stopped, NOx is not reduced at the NOx catalyst 12. Therefore, NOx flown into the NOx catalyst 12 is emitted from the NOx catalyst 12 without being reduced.

The step S320 is not performed every time when the error detection routine is executed, but is performed only when it is determined that the NOx sensor 30 can have an error at step S318. Thereby, it is possible to decrease the amount of NOx that is emitted from the NOx catalyst 12 in detecting the error of the NOx sensor 30.

In step S322, the ECU 40 sums up the variation of concentration of NOx, which is detected by the NOx sensor 30, to the cumulative value for a predetermined period of time. Then, at step S326, the ECU 40 checks the error of the NOx sensor 30 by determining whether the cumulative value of the variation of the concentration of NOx is within the predetermined range or not.

If the cumulative value of the variation of the concentration of NOx is within the predetermined range (Yes at step S326), the ECU 40 determines that the NOx sensor 30 correctly detects the amount of NOx, which is emitted from the NOx catalyst 12 while the supply of the aqueous urea solution from the urea addition valve 14 to the NOx catalyst 12 is stopped. Then, the ECU 40 ends the error detection routine.

If the cumulative value of the variation of the concentration of NOx is out of the predetermined range (No at step S326), the ECU 40 determines that the NOx sensor 30 does not correctly detect the amount of NOx, which is emitted from the NOx catalyst 12 while the supply of the aqueous urea solution from the urea addition valve 14 to the NOx catalyst 12 is stopped. And the ECU 40 determines that the NOx sensor 30 has an error.

As described above, in this embodiment, the error of the NOx sensor 30 is detected on the basis of the amount of NOx, which is detected in the predetermined period in the engine running time, which includes the period when the running state of the engine 2 is unsteady. When the running state of the engine 2 is unsteady, more NOx is left without being reduced and is emitted from the NOx catalyst 12 than when the running state of the engine 2 is steady. Therefore, it is possible to detect the error of the NOx sensor 30 with high accuracy on the basis of the detected amount of NOx.

Moreover, NOx emitted from the NOx catalyst 12 in the unsteady running state of the engine 2 is emitted not by the error detection of the NOx sensor 30 but by the response delays of the aqueous urea supply operation of the urea addition valve 14 and the NOx removal action at the NOx catalyst 12 in the unsteady running state. Thereby, it is possible to decrease the amount of NOx, which is emitted from the NOx catalyst 12 in detecting the error of the NOx sensor 30.

### Other Embodiments

In the above-described embodiment, the ECU 40 determines that the NOx sensor 30 has an error when the cumulative value of the variation of the concentration of NOx during the predetermined period, which includes the unsteady running states of the engine 2, is out of the predetermined range, i.e., smaller than or larger than the predetermined range. In contrast, it is also possible to determine that the NOx sensor 30 has no error when the cumulative value of the variation of the concentration of NOx is equal to or larger than a predetermined value and to determine that the NOx sensor 30 has an error when the cumulative value of the variation of the concentration of NOx is smaller than the predetermined value.

In the above-described embodiment, the error of the NOx sensor 30 is checked by stopping or decreasing the supply of the aqueous urea solution after it is once determined that the NOx sensor can have an error. In contrast, it is also possible to determine that the NOx sensor 30 has an error when the error of the NOx sensor is detected for the first time.

In the above-described embodiment, the control program memorized in the storage device of the ECU 40 such as the ROM and the flash memory lets the ECU 40 function as the running state detector, the unsteady state determiner, the NOx amount retriever, the NOx amount cumulator, the error determiner, the reducer calculator, the NOx remover controller and the error checker. In contrast, it is also possible to provide at least one of the above-listed functions by a logic circuit provided in the ECU 40.

The error detection apparatus for NOx sensor according to the present invention may be applied not only to the diesel engine 2 but also to other kinds of internal combustion engines such as a gasoline engine, in which fuel is combusted and from which NOx is emitted.

Additional advantages and modifications will readily occur to those skilled in the art. The invention in its broader terms is therefore not limited to the specific details, representative apparatus, and illustrative examples shown and described.

What is claimed is:

1. An error detection apparatus for detecting an error of a NOx sensor, which is located on a downstream side of a NOx remover in a discharge passage of an internal combustion engine to detect an amount of NOx that is left without being removed by the NOx remover, the apparatus comprising:
a running state detector that detects a running state of the internal combustion engine;
an unsteady state determiner that determines whether the running state of the internal combustion engine detected by the running state detector is an unsteady state or not;
a NOx amount retriever that retrieves the detected amount of NOx on the downstream side of the NOx sensor by receiving an output signal of the NOx sensor; and
an error determiner that determines the error of the NOx sensor on the basis of the amount of NOx that is retrieved by the NOx amount retriever during a predetermined period under the running state of the internal combustion engine including the unsteady state determined by the unsteady state determiner.

2. The error detection apparatus according to claim 1, wherein:
the running state detector detects a fuel injection quantity of the internal combustion engine; and
the unsteady state determiner determines that the running state of the internal combustion engine is the unsteady state at least when a variation of the fuel injection quantity is equal to or larger than a predetermined value.

3. The error detection apparatus according to claim 1, further comprising
a NOx amount cumulator that calculates a cumulative value of the amount of NOx that is retrieved by the NOx amount retriever during the predetermined period,
wherein the error determiner determines the error of the NOx sensor on the basis of the cumulative value of the amount of NOx, which is calculated by the NOx amount cumulator.

4. The error detection apparatus according to claim 1, further comprising
a NOx amount cumulator that calculates a cumulative value of a variation of the amount of NOx that is retrieved by the NOx amount retriever during the predetermined period,
wherein the error determiner determines the error of the NOx sensor on the basis of the cumulative value of the variation of the amount of NOx, which is calculated by the NOx amount cumulator.

5. The error detection apparatus according to claim 1 wherein:
the running state detector detects an engine speed and a fuel injection quantity of the internal combustion engine; and
the NOx remover includes a NOx catalyst and a reducer addition device that supplies reducing agent to the NOx catalyst to reduce and remove NOx, the apparatus further comprising
a reducer calculator that calculates an amount of the reducing agent that is supplied from the reducer addition device to the NOx catalyst with reference to a map in accordance with the engine speed and the fuel injection quantity.

6. The error detection apparatus according to claim 1, further comprising:
a NOx remover controller that stops or slows down an operation of the NOx remover when the error determiner determines the error of the NOx sensor; and
an error checker that checks the error of the NOx sensor on the basis of the amount of NOx that is retrieved by the NOx amount retriever after the NOx remover stops or slows down the operation of the NOx remover.

7. An exhaust gas cleaning system comprising:
a NOx remover that is located in a discharge passage of an internal combustion engine;
a NOx sensor that is located on a downstream side of the NOx remover in the discharge passage; and
the error detection apparatus according to claim 1.
